(19) United States
(12) Patent Application Publication
(10) Pub. No.: US 2005/0002768 A1
(43) Pub. Date: Jan. 6, 2005

(54) Loading floor for a vehicle and loading apparatus

(75) Inventors: Albrecht Nick, Isenbuttel (DE); Geisslinger Jurgen, Ellingen (DE); Wulf Thoma, Gifhorn (DE)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(73) Assignee: SAI Automotive SAL GmbH, Hagenbach (DE)

(21) Appl. No.: 10/727,839

(22) Filed: Dec. 3, 2003

Related U.S. Application Data
(63) Continuation of application No. PCT/EP03/05353, filed on May 22, 2003.

(30) Foreign Application Priority Data
May 22, 2002 (DE) 102 23 041.2

(51) Int. Cl. B60P 1/00

(52) U.S. Cl. 414/522

(57) ABSTRACT

A loading apparatus for a vehicle, with loading floor provisioned in loading area of the vehicle, with a first set of elements for the vertical adjustment of loading floor within loading area, with a second set of elements for the horizontal movement of loading floor, specifically for extending and retracting loading floor out of and into loading area, and with drive elements for driving elements the first set of elements for the vertical adjustment of loading floor, wherein the second set of elements also serve to drive the first set of elements for the horizontal movement of loading floor.

### RELATED APPLICATION

This application is a continuation of International Application PCT/EP03/05353 filed May 22, 2003, the contents of which are here incorporated by reference in their entirety.

### BACKGROUND OF THE INVENTION

1. Field of the Invention

The invention relates to a loading floor for a vehicle and to a loading apparatus according to the characteristics and teachings of the disclosure herein.

2. Prior Art

Various pull-out loading floors and loading apparatuses are known from the state of the art. A pull-out loading surface for station wagons is known from DE-OS 23 02 972, wherein guide rails are provisioned on the loading surface of the vehicle. The pull-out loading surface is mounted on these guide rails and can be moved on the guide rails on rollers. The items to be loaded can then be set onto the pulled out loading surface and pushed into the loading area of the vehicle.

A loading apparatus for personal vehicles or transportation vehicles is known from DE 296 08 955 U1. This loading apparatus consists of a guide element that is mounted on the floor of the loading area of the vehicle. A movable loading plate is located on the guide element and can be moved from a transportation position inside the loading area into a loading or unloading position, in which the loading plate is located outside of the vehicle, behind the rear of the vehicle.

A loading apparatus on an automobile with a swinging rear hatch is known from DE 196 19 126 A1. Fastened guide rails that run along the length of the vehicle are provisioned on both sides of the floor of the rear loading area, which can be closed by the rear hatch of the vehicle, Loading requires that the rear hatch is moved to the back into a horizontal loading position along a lower axis that runs traverse to the vehicle.

A loading floor for the loading area of a vehicle is known from DE 197 49 158 C2. The loading floor is mounted on rollers so that it can be moved, and can be partially pulled out of the loading area approximately parallel to the vehicle. The loading floor exhibits a crumple zone, provisioned traverse to the length of the car, in order to improve crash behavior.

A pull-out loading floor for a vehicle is known from DE 197 31 324 A1, which can be moved by means of rollers along support rails. The support rails are connected to the vehicle body such that their height can be adjusted. The height adjustment occurs by means of two parallelogram steering devices, with the help of an adjustment cylinder.

A further loading floor is known from U.S. Pat. No. 3,132,755, which can be pulled out of the loading area on guide rails approximately parallel to the vehicle floor.

Pull-out loading floors and loading apparatuses of the type mentioned allow for simplified loading and unloading of the vehicle by setting the freight on the rolling loading floor. A load placed onto the pulled out loading floor can be pushed, along with the loading floor, into the interior of the vehicle without requiring much force.

However, a common disadvantage of the previously known loading apparatuses is that, due to the pull-out mechanism for the loading floor, a considerable amount of loading area is lost.

### SUMMARY OF THE INVENTION

The object of the invention is therefore to provide an improved loading apparatus for a vehicle, in particular for an automobile with a rear hatch. The object of the invention is fulfilled by the characteristics and teachings hereof of the preferred embodiments disclosed herein and those structures having the characteristics thereof and covered by the claims appended hereto.

A special advantage of the invention is that the usable loading area is not, or is only minimally, reduced by the lift/pull-out loading floor and the corresponding loading apparatus. According to a preferred embodiment, this is accomplished such that parallelogram steering elements are provisioned for the height adjustment of the loading floor.

The parallelogram steering elements are linked to the vehicle floor at one end. The other end of each parallelogram steering element lies on the lower side of the loading floor. At least one of the parallelogram steering elements is configured so that it can be driven for adjusting the height of the loading floor.

According to a preferable embodiment of the invention, at least one of the parallelogram steering elements exhibits a toothed segment, by means of which a driving force can be introduced, by means of a shaft, in order to raise or lower the loading floor. As pertains to this, the shaft is driven by a drive mechanism provisioned on the loading floor. The drive mechanism is preferably an electromechanical drive mechanism.

According to a further preferable embodiment of the invention, the toothed segment has a curved shape, in particular in the form of a circular segment. The curved or circular form can be configured concave or convex, with regard to the lower side of the loading floor.

According to a further preferable embodiment of the invention, the drive mechanism is provisioned on the lower side of the loading floor. Provisioning the drive mechanism on the lower side of the loading floor allows for a particularly space-saving configuration of the loading apparatus according to the invention, so that no or only little usable loading space is lost.

According to a further preferable embodiment of the invention, the drive mechanism is provisioned on the side of the loading floor that lies across from the loading edge of the vehicle in the retracted state of the loading floor. Thus, when the loading floor is extended, the drive mechanism fastened to the loading floor moves towards the loading edge.

According to a further preferable embodiment of the invention, a rack is provisioned between at least two parallelogram steering elements provisioned after one another in a horizontal direction. The rack serves to introduce force for moving the loading floor horizontally.

According to a further preferable embodiment form of the invention, the toothed segment and the rack are provisioned such that the shaft, for example when raising and extending the loading floor, first passes over the toothed segment, for the height adjustment of the loading floor, and then continues moving along the rack in order to realize a translatory outward-pushing motion of the loading floor.

According to a further preferable embodiment form of the invention, a control device is provisioned for the loading floor and the rear hatch of the vehicle. A user can input a movement command for the loading floor into the control device. For this purpose a corresponding operating element is provisioned on the instrument panel and/or in the loading area, and/or on a remote control.

Movement commands can be input by means of this, at least one, operating element, for example for extending or retracting the loading floor. If, for example, an extension movement command is input into the control element, the control element first initiates the automatic opening of the rear hatch of the vehicle before the drive mechanism of the loading floor is activated. Appropriate actions occur in the opposite case when retracting the loading floor. The drive mechanism of the loading floor is first activated and, after the loading floor is retracted, the rear hatch is automatically closed.

As concerns the invention at hand, it is especially advantageous that lifting and extending the loading floor, as well as the lowering and retraction of the loading floor, can occur fully automated. This is possible due to the drive mechanism, which is provisioned on the loading floor itself. As concerns this, it is especially advantageous that manual force is not required for either extending or retracting the loading floor.

The invention at hand further allows for the loading floor to be in a defined position in every state of operation. With regard to this, the defined position of the loading floor is reached through appropriate control of the drive mechanism.

### BRIEF DESCRIPTION OF THE DRAWINGS

Further, preferred embodiments of the invention are explained in more detail in conjunction with the drawings. They show:

FIG. 1 shows a schematic side view of a first embodiment form of a loading apparatus according to the invention,

FIG. 2 shows a perspective view of the loading apparatus from FIG. 1,

FIG. 3 shows a perspective detail-view of the loading apparatus from FIGS. 1 and 2,

FIG. 4 shows a perspective view of the loading apparatus from FIG. 1, 2 and 3 with raised loading floor,

FIG. 5 shows a perspective detail-view from FIG. 4,

FIG. 6 shows a perspective view of a further embodiment form of the loading apparatus in the loading area of a vehicle,

FIG. 7 shows the perspective view from FIG. 6 with extended loading floor.

### DETAILED DESCRIPTION OF PREFERRED EMBODIMENTS OF THE INVENTION

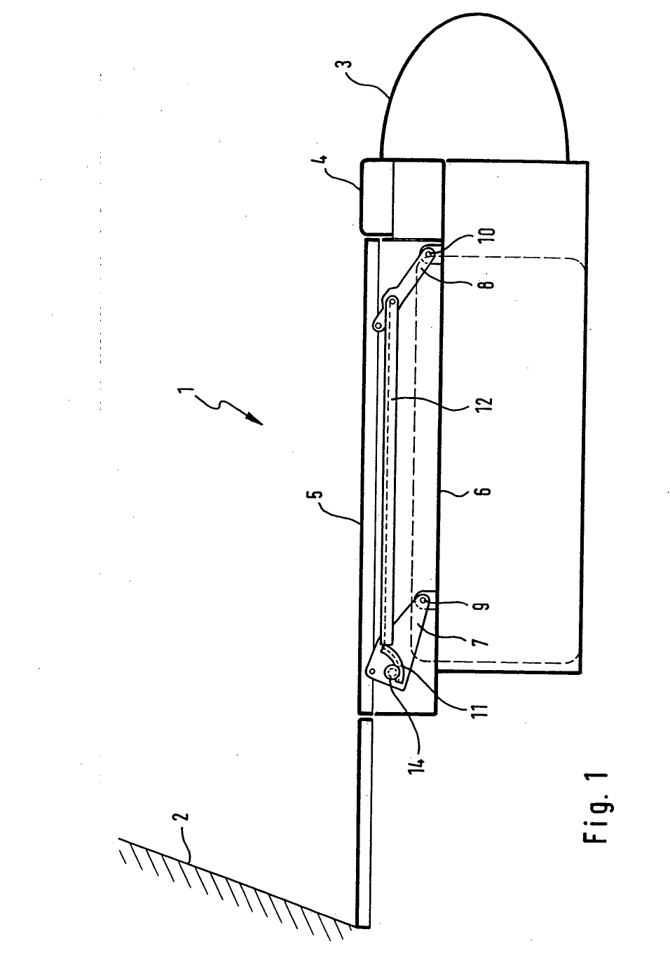

In a schematic side view, FIG. 1 shows loading area 1 of a vehicle, bordered by rear seat 2 towards the front of the vehicle. Loading edge 4 is located above fender 3 of the vehicle. Loading floor 5 is located behind loading edge 4.

Parallelogram steering elements 7 and 8 are provisioned on vehicle floor 6. Parallelogram steering elements 7 and 8 are connected with vehicle floor 6 such that they can move around axles 9, or 10 respectively. It is preferable that there is a pair of parallelogram steering elements 7 and 8 on each side of the vehicle, so that loading floor 5 lies on parallelogram steering elements 7 and 8.

Toothed segment 11 is located in parallelogram steering elements 7, which are the front parallelogram steering elements, with respect to the vehicle. Toothed segment 11 serves to introduce a driving force from a drive mechanism fastened to the lower side of loading floor 5 in order to lift loading floor 5, by means of a swinging motion of parallelogram steering elements 7 and 8 around axles 9, or 10 respectively.

Rack 12 is located between parallelogram steering elements 7 and 8. Rack 12 serves to introduce a driving force from the drive mechanism, provisioned on the lower side of loading floor 5, in order to extend loading floor 5 outwards over loading edge 4, or to retract it back inwards.

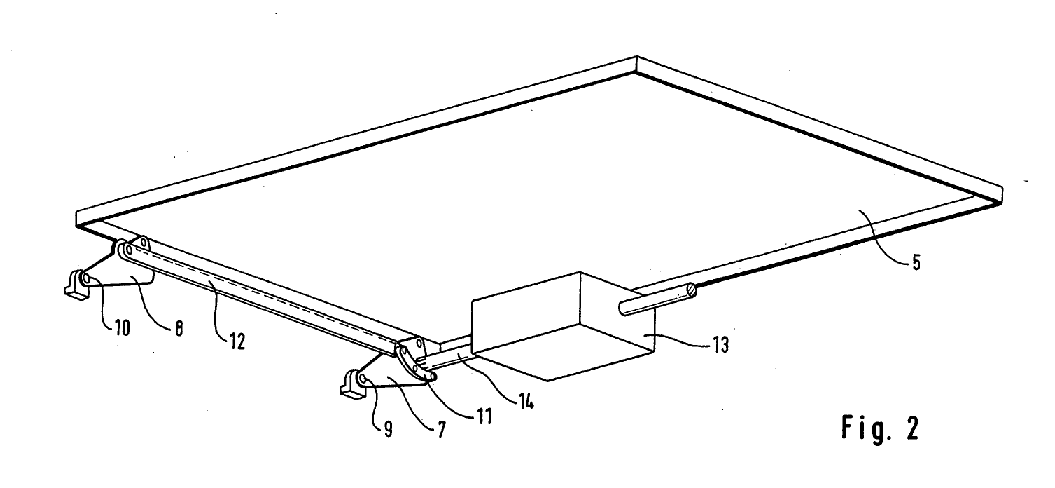

FIG. 2 shows a perspective view of the loading apparatus from FIG. 1 from below. Elements in FIG. 2 that correspond to elements from FIG. 1 are identified by the same numbers. FIG. 2 shows the loading floor in the same position as in FIG. 1, that is, in the retracted state. For the sake of visibility, only one pair of parallelogram steering elements 7 and 8, with toothed segment 11 and rack 12 on the left side of the vehicle, are shown in FIG. 2; it is preferable that the same configuration is also present on the other side of the vehicle.

Drive mechanism 13 is located on the lower side of loading floor 5. Drive mechanism 13 preferably contains an electric motor, which is controlled by a control device.

Drive mechanism 13 drives shaft 14. In the position of loading floor 5 shown in FIG. 2, shaft 14 engages an outer region of toothed segment 11. By activating drive mechanism 13, shaft 14 rotates counterclockwise, so that shaft 14 runs over toothed segment 11. In the process, driving force from shaft 14 is exerted on toothed segment 11, as the result of which parallelogram steering elements 7 and 8 swing around axles 9, or 10 respectively, so that loading floor 5 is raised.

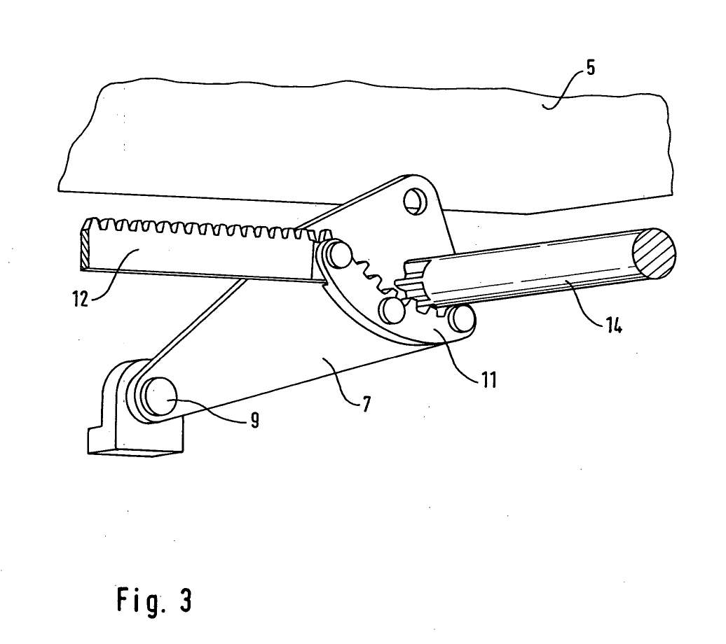

For the purpose of clarification, FIG. 3 shows a detail-view of parallelogram steering element 7 with toothed segment 11, which is engaged by shaft 14:

Toothed segment 11 and rack 12 are provisioned such that they are directly adjacent, that is, shaft 14 first runs over toothed segment 11, so that loading floor 5 is lifted, after which shaft 14 runs over rack 12, so that the loading floor is pushed out in a horizontal translatory motion. This process of movement is reversible, that is, in order to retract loading floor 5, shaft 14 is driven in the opposite direction so that the loading floor is moved back into the loading area in a horizontal direction along rack 12, after which it is lowered to its fully retracted position through the motion of shaft 14 along toothed segment 11.

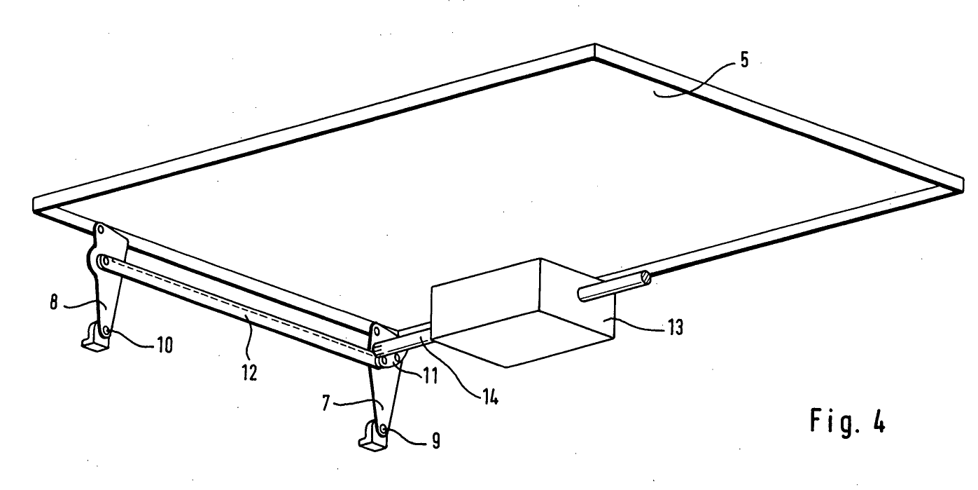

For the purpose of clarification FIG. 4 shows the representation from FIG. 2, where loading floor 5 is in its raised position. From this position, the movement of loading floor 5 changes to a horizontal translatory movement, in order to extend loading floor 5 out of the loading area along rack 12.

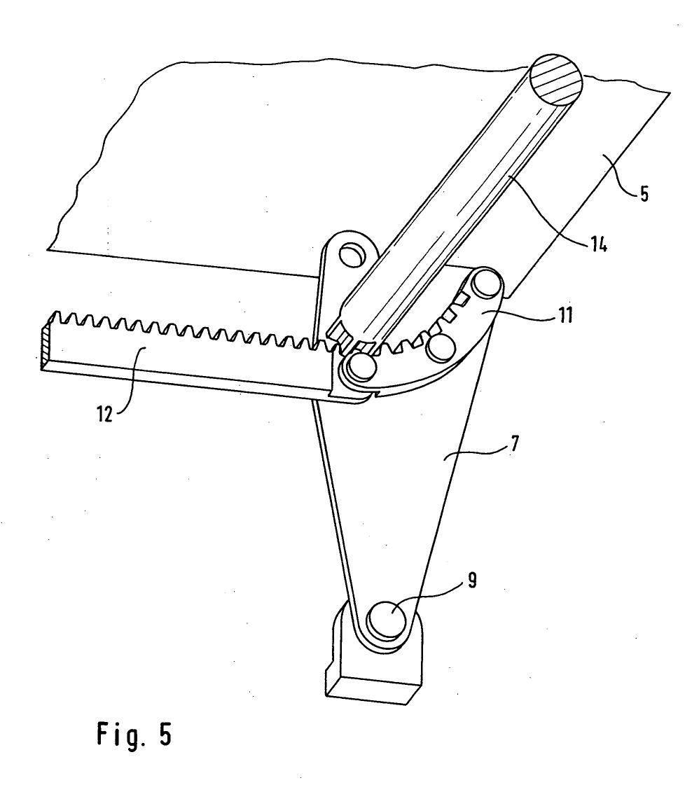

The position of parallelogram steering element 7, with toothed segment 11 and rack 12, shown in FIG. 5 depicts the transition from the lifting of loading floor 5 to the outward extension of loading floor 5 by means of running shaft 14 over rack 12.

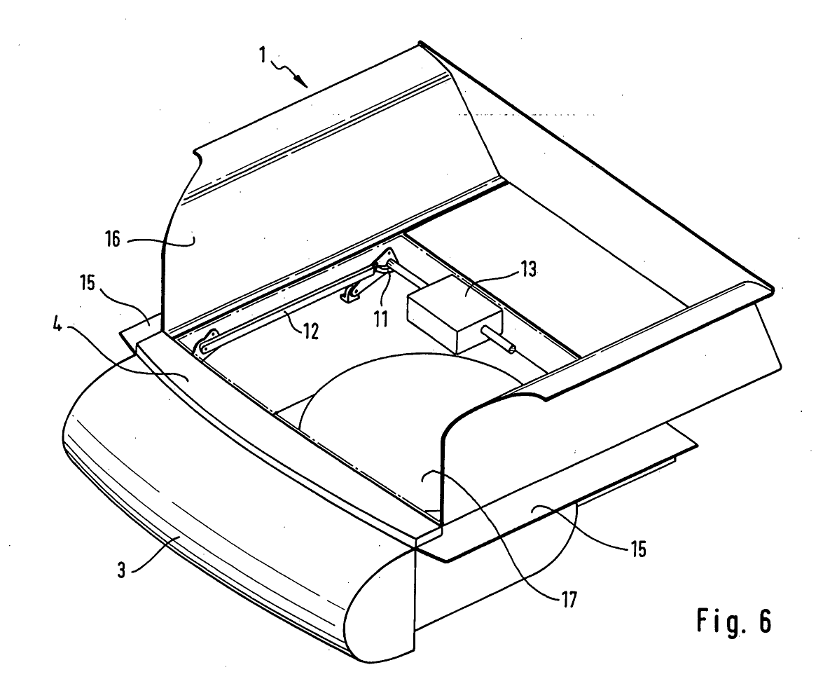

FIG. 6 shows a perspective view of the loading area of a vehicle with rear hatch. Elements in FIG. 6 that correspond to elements from FIGS. 1 through 5 are identified with the same numbers.

A loading apparatus according to the invention is located in loading area 1 of the vehicle in its retracted state. Loading area 1 is bordered by body 15 of the vehicle and panel 16.

Spare tire 17 is provisioned on the vehicle floor. Drive mechanism 13 of the loading apparatus is located approximately in the middle of the vehicle, behind spare tire 17. With regard to this, it is especially advantageous that the build height of drive mechanism 13 does not exceed the height required to accommodate the spare tire under loading floor 5, so that no usable loading area is lost.

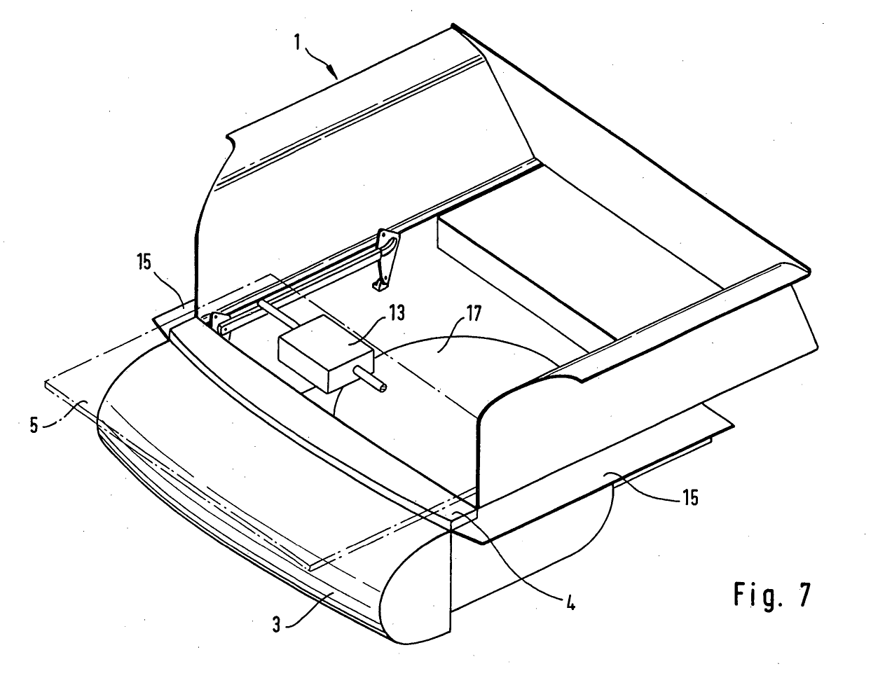

FIG. 7 shows loading floor 5 in its extended state. In this position, drive mechanism 13 is located on the lower side of loading floor 5 in the proximity of loading edge 4, that is, loading floor 5 has been raised, together with its drive mechanism 13, out of the position shown in FIG. 6 and moved out of loading area 1. In this process, drive mechanism 13 has moved in the direction of loading edge 4.

One or multiple operating elements are present, for example, on the instrument panel, in loading area 1 and/or on the vehicle's remote control, for the purpose of operating the loading apparatus, that is, for extending or retracting the loading floor. Appropriate movement commands can be input for loading floor 5 by means of these operating elements. If, for example, a user gives the command to extend the loading floor, then this command is received by the control device of the vehicle. The control device then transmits a control impulse in order to activate drive mechanism 13, so that loading floor 5 is raised and then extended outwards.

Accordingly, in order to retract loading floor 5, a movement command is issued so that drive mechanism 13 is activated so that it exerts the opposite rotation until loading floor 5 is fully retracted.

It is preferable that the vehicle exhibits an apparatus for automatically opening and closing the rear hatch. Such apparatuses are already known from the state of the art. It is also preferable that such apparatuses for automatically opening and closing the rear hatch are also controlled by the control device. In this case, if a movement command is issued, the opening and closing of the rear hatch is coordinated appropriately, that is, if a command to extend loading floor 5 is input, the rear hatch is first opened automatically before the loading floor is extended. Accordingly, the rear hatch is automatically closed again after loading floor 5 has been retracted.

Legend

| | |
|---|---|
| loading area | 1 |
| rear seat | 2 |
| fender | 3 |
| loading edge | 4 |
| loading floor | 5 |
| vehicle floor | 6 |
| parallelogram steering element | 7 |
| parallelogram steering element | 8 |
| axle | 9 |
| axle | 10 |
| toothed segment | 11 |
| rack | 12 |
| drive mechanism | 13 |
| shaft | 14 |
| body | 15 |
| panel | 16 |
| spare tire | 17 |

1. Loading apparatus for a vehicle, with loading floor provisioned in loading area of the vehicle, with elements for the vertical height adjustment of loading floor within loading area with elements for the horizontal movement of loading floor, specifically for extending and retracting loading floor out of and into loading area and with drive elements for driving elements for the vertical height adjustment of loading floor
wherein
drive elements also serve to drive elements for the horizontal movement of loading floor.

2. Loading apparatus according to claim 1, wherein the elements for height adjustment exhibit parallelogram steering elements, and at least one of the parallelogram steering elements can be driven by the drive elements.

3. Loading apparatus according to claim 2, wherein at least one of the parallelogram steering elements exhibits toothed segment, and the drive elements exhibit shaft, which is configured for driving the toothed segment.

4. Loading apparatus according to claim 3, wherein the toothed segment is configured to have a curved shape, in particular in the form of a circular segment.

5. Loading apparatus according to claim 1, wherein the elements for horizontal movement exhibit rack, which is provisioned between at least two parallelogram steering elements, which are provisioned one after the other in the direction of the horizontal movement, and wherein the drive elements exhibit shaft, which is configured to introduce a driving force to the rack for the horizontal movement of the loading floor.

6. Loading apparatus according to claim 4, wherein the toothed segment and the rack are provisioned such that the shaft runs over the toothed segment during the height adjustment of the loading floor, and that the shaft runs over the rack during the horizontal movement of the loading floor.

7. Loading apparatus according to claim 1, wherein the drive elements are provisioned on the lower side of the loading floor in the retracted state, on the side of the loading floor across from loading edge.

8. Loading apparatus according to claim 1, wherein the drive elements exhibit an electric drive mechanism.

9. Loading apparatus according to claim 1, wherein input elements are provisioned for inputting movement commands into a control device for the loading floor, and with elements for automatically opening and/or closing a rear hatch of the vehicle, where the elements for automatically opening and closing are coupled to the control device such that the rear hatch opens when the loading floor is extended, and/or so that the rear hatch closes when the loading floor is retracted.
